(19) United States
(12) Patent Application Publication
(10) Pub. No.: US 2026/0356167 A1
(43) Pub. Date: Nov. 12, 2026

(54) SYSTEMS AND METHODS FOR FLOWING HYDRAULIC FLUID IN MOBILE MACHINES

(71) Applicant: Caterpillar Inc., Peoria, IL (US)

(72) Inventors: Xinqiang Xu, Dunlap, IL (US); Xinyu Ge, Peoria, IL (US); Liang Wang, Dunlap, IL (US); Mo Wei, Dunlap, IL (US); Siyi Zhou, Dunlap, IL (US)

(73) Assignee: Caterpillar Inc., Peoria, IL (US)

(21) Appl. No.: 19/199,753

(22) Filed: May 6, 2025

(51) Int. Cl. B60H 1/32; B60P 1/04; B60T 1/06; B60T 11/28

(52) U.S. Cl. CPC B60H 1/3205; B60P 1/04; B60T 1/065; B60T 11/28

(57) ABSTRACT

A mobile machine including: a cab including an interior; an electric drive system; at least one wheel configured to be driven by the electric drive system; a bed; and a wet brake system configured to slow rotation of the at least one wheel during a braking event, the wet brake system including: a hydraulic fluid supply configured to supply hydraulic fluid; a brake configured to receive the hydraulic fluid from the hydraulic fluid supply, the brake configured to slow rotation of the at least one wheel during the braking event; a first heat exchanger configured to provide heat for the bed; a second heat exchanger configured to provide heat for heating the interior of the cab; and a control system configured to generate commands to cause flow of the hydraulic fluid from the brake to one or both of the first heat exchanger or the second heat exchanger.

### TECHNICAL FIELD

The present disclosure relates generally to mobile machines, and, more specifically, to systems and methods for flowing hydraulic fluid through heat exchangers in mobile machines.

### BACKGROUND

Mobile machines in the form of large mining trucks (LMTs) often include internal combustion engines (ICEs) that combust fuel to provide power to propel the machines across the ground surfaces of worksites. The LMTs include beds that are loaded with materials such as surface material or ores, and the LMTs transport the materials between locations on the worksites. The ICEs also provide power, via a hydraulic system, to tip the beds, so that the materials in the beds are dumped at the dumpsites on the worksites.

When the LMTs operate in cold climates, there is a tendency for the cold materials in the beds to adhere to the walls and bottoms of the beds during dumping. Operation of the ICEs produce a vast quantity of heat as well as hot exhaust. The hot exhaust is often used to heat both the beds of the LMTs, as well as the materials that are within the beds of the LMTs. Heating the beds and the materials prevents the materials from adhering to the bed when dumping the materials from the beds. The LMTs often include heaters to heat the interiors of the cabs of the machines.

However, some LMTs use electrical systems including motors and batteries, rather than ICEs, to produce power to operate the machines. Operation of these electrical systems produces relatively little heat, which is insufficient to heat the beds of the machines, or to heat the cabins of the machines. Further, the electrical systems themselves producing power to operate electrical heaters that heat the beds of the LMTs or the insides of the cabs and will quickly draw batteries and limit the machine operation duration.

DE 10 2011 056 287 A1 (“DE '287”) is directed to a cooling system for a fork-lift truck that includes a diesel internal combustion engine. DE '287 discloses that electrical energy generated during electrical braking is converted to heat, and the heat is used to heat up the diesel engine, thereby decreasing the length of time it takes for the diesel engine to fully warm up. However, DE '287 does not disclose heating an interior of a cab of a machine, or heating a bed used to haul materials, for a machine does not include a diesel internal combustion engine.

Accordingly, systems and methods of the present disclosure may address or solve one or more problems in the art. However, the scope of the current disclosure is defined by the attached claims, and not by the ability to solve any specific problem.

### SUMMARY

In some aspects of the disclosure, a mobile machine comprises: a cab including an interior; an electric drive system; at least one wheel configured to be driven by the electric drive system; a bed configured to receive materials and to dump the materials at a dumpsite; and a wet brake system configured to slow rotation of the at least one wheel during a braking event, the wet brake system comprising: a hydraulic fluid supply configured to supply hydraulic fluid; a brake configured to receive the hydraulic fluid from the hydraulic fluid supply, the brake configured to slow rotation of the at least one wheel during the braking event; a first heat exchanger configured to provide heat for the bed; a second heat exchanger configured to provide heat for heating the interior of the cab; and a control system configured to generate commands to cause flow of the hydraulic fluid from the brake to one or both of the first heat exchanger or the second heat exchanger.

In some aspects of the disclosure, a wet brake system configured to apply braking to reduce a speed of a wheel of a mobile machine during a braking event, comprises: a hydraulic fluid supply configured to supply hydraulic fluid; a brake configured to receive the hydraulic fluid from the hydraulic fluid supply, the brake configured to apply braking to reduce the speed of the wheel during the braking event; a first heat exchanger configured to provide heat for increasing a temperature of a bed of the mobile machine which is configured to receive materials; a second heat exchanger associated with a heat pump configured to heat a cab of the mobile machine; and a control system configured to generate commands to cause a flow of the hydraulic fluid from the brake to one or both of the first heat exchanger or the second heat exchanger.

In some aspects of the disclosure, a mobile machine comprises: an electric drive system including batteries configured to provide electrical power and a motor configured to operate on the electrical power; a cab including an interior; a heat pump configured to heat the interior of the cab; a wheel configured to be driven by the electric drive system, the wheel configured to propel the mobile machine across a ground surface of a worksite; a bed configured to receive materials and to dump the materials at a dumpsite on the worksite; and a brake system configured to slow rotation of the wheel during a braking event, the brake system comprising: a hydraulic fluid supply configured to supply hydraulic fluid; a brake configured to receive the hydraulic fluid from the hydraulic fluid supply, the brake configured to slow the rotation of the wheel during the braking event; a first heat exchanger configured to heat the bed; a second heat exchanger configured to heat a volume of air surrounding the heat pump; a control valve configured to flow hydraulic fluid from the brake to one or both of the first heat exchanger or the second heat exchanger; and a control system configured to control operation of the control valve to flow the hydraulic fluid from the brake to one or both of the first heat exchanger or the second heat exchanger, based on at least one of i) whether the cab is occupied, ii) a temperature within the cab, iii) a distance between the mobile machine on the worksite and the dumpsite, or iv) an ambient temperature.

### BRIEF DESCRIPTION OF THE DRAWINGS

The accompanying drawings, which are incorporated in and constitute a part of this specification, illustrate various aspects of the disclosure, and, together with the description, serve to explain aspects of the disclosure.

FIG. 1 illustrates a side view of an exemplary machine, in accordance with some aspects of the disclosure.

FIG. 2 illustrates a schematic diagram of an exemplary wet brake system of the machine of FIG. 1, in accordance with some aspects of the disclosure.

FIG. 3 illustrates a schematic block diagram of an exemplary operation of a control system of the wet brake system of FIG. 2, according to aspects of the disclosure.

FIG. 4 illustrates an exemplary flow chart describing a method of operating the wet brake system of FIG. 2, in accordance with some aspects of the disclosure.

### DETAILED DESCRIPTION

Both the foregoing general description and the following detailed description are exemplary and explanatory only and do not restrict the claims. The terms “comprises,” “comprising,” “having,” “including,” or other variations thereof used herein cover a non-exclusive inclusion such that a process, method, article, or apparatus that comprises a list of elements does not include necessarily only those elements, but may include other elements not expressly listed or inherent to such a process, method, article, or apparatus. Further, relative terms, such as, for example, “about,” “substantially,” “generally,” “approximately,” or other variations thereof, include a possible variation of ±10% in a stated value, unless stated otherwise. Still further, the terms “one or more,” “at least one,” and variations thereof, include one, two, or more than two (e.g., a plurality). Additionally, terms such as “top” and “bottom” are exemplary only and may refer to an orientation of a component in a particular figure, for example, and do not require that the component is oriented such that a “top” is above a “bottom.”

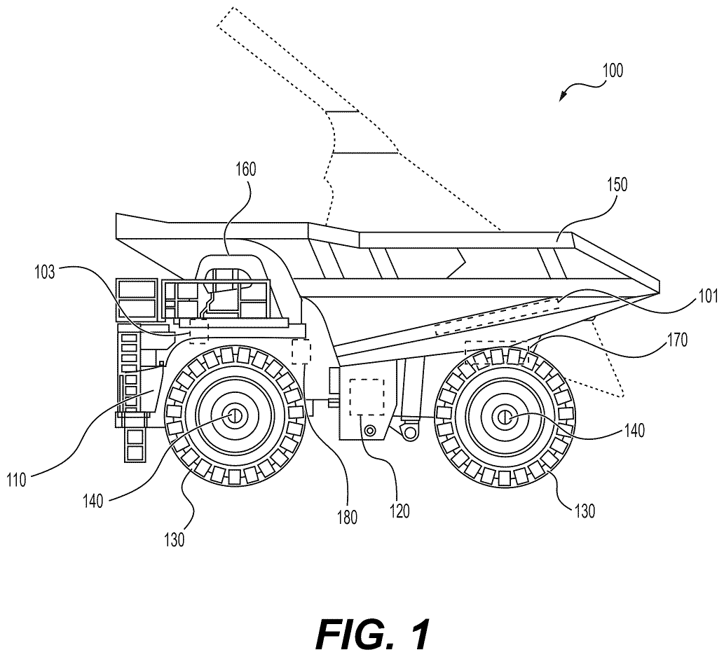

With reference to the drawings, FIG. 1 illustrates a side view of an exemplary machine 100, in accordance with some aspects of the disclosure. Although FIG. 1 shows the machine 100 as a mobile machine in the form of a large mining truck (LMT), aspects of the current disclosure are applicable to other machines, such as but not limited to articulated trucks, off highway trucks, or other types of dump trucks, among other machines. As FIG. 1 shows, the machine 100 may include a heat pump 103, a frame or chassis 110, an electric drive system 120, wheels 130, axles 140, a bed 150 including a heat exchanger 101, a cab 160, a wet brake system 170, and one or more sensors 180, among other components, as further described.

In some examples, as FIG. 1 shows, the machine 100 may be in the form of an electric vehicle, and may omit an internal combustion engine (ICE) or other engine or power source that combusts (e.g., burns) fuel to power the machine 100. Thus, as shown in FIG. 1, the machine 100 may include the electric drive system 120 installed within or otherwise connected to the chassis 110. The electric drive system 120 may include one or more batteries as well as one or more hydraulic pumps or electric motors, among other components. The batteries may power the electric motors, and the electric motor may rotate or drive one or multiple axles 140, to which the wheels 130 are connected, to thereby propel the machine 100 across the ground surface of the worksite. The electric drive system 120 also may provide electrical power to a mechanism to tip the bed 150 (FIG. 1 showing the bed 150 in an untipped position in solid lines, and showing the bed 150 in a tipped position in dashed lines), such that materials loaded in the bed 150 at one location on the worksite may be transported by the machine 100 to a dumpsite at another location on the worksite, where the materials in the bed 150 are dumped. When the machine 100 is operated by an operator located within the machine (such as when the machine 100 is not in fully autonomous operation, or when the machine 100 is not operated remotely), the operator may sit within the cab 160 of the machine 100. The machine 100 may also include the wet brake system 170, which is configured to provide a braking force to the wheels 130 or the axles 140, as further described. The sensors 180 may sense different conditions of the machine 100, also as further described.

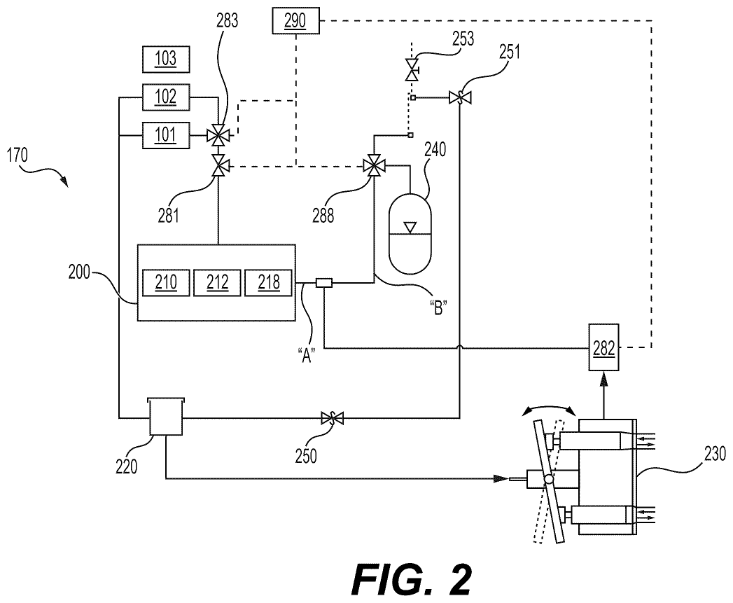

FIG. 2 illustrates a schematic diagram of the wet brake system 170, in accordance with some aspects of the disclosure. As FIG. 2 shows, the wet brake system 170 may include a brake 200. The brake 200 may include a plurality of friction discs 210, a plurality of separator discs 212, and a brake actuator 218. The friction discs 210 may be connected to and thus may rotate with either or both of the axles 140, and the separator discs 212 may be disposed between the friction discs 210 in the same housing that houses the friction discs 210. During a braking event, the brake actuator 218 may flow high-pressure hydraulic fluid into the brake 200, which may push the friction discs 210 and the separator discs 212 toward one another. As the friction discs 210 and the separator discs 212 approach one another, frictional torque may be generated between the friction discs 210 and the separator discs 212, and as a result rotation or a speed of the axles 140 may be slowed or reduced. This frictional torque generated during the braking event may heat the high-pressure hydraulic fluid, and this heated high-pressure hydraulic fluid then should be cooled to prevent degradation of the hydraulic fluid as well as damage to components of the brake 200.

The hydraulic fluid may be provided to the brake 200 by a low-pressure hydraulic fluid supply 220, a hydraulic fluid pump 230, and a control valve 282. The hydraulic fluid pump 230 may receive low-pressure hydraulic fluid from the low-pressure hydraulic fluid supply 220, may pressurize the hydraulic fluid, and may flow the high-pressure hydraulic fluid to the brake 200, for operation during the braking event, as described. In accordance with some aspects of the disclosure, the control valve 282 may be positionable to control the amount of high-pressure hydraulic fluid supplied to the brake 200. The low-pressure hydraulic fluid supply 220 also may be connected to a check valve 250 and an automatic relief valve 251, which may flow excess hydraulic fluid from the low-pressure hydraulic fluid supply 220 either through manual valve 253, to remove the excess hydraulic fluid from the wet brake system 170, or through a control valve 288 that may be positioned in a first position to flow the excess hydraulic fluid from the low-pressure hydraulic fluid supply 220 to a piston accumulator 240, the piston accumulator 240 configured to receive and hold the excess hydraulic fluid for subsequent use when required by the wet brake system 170.

The wet brake system 170 may be configured to flow the hydraulic fluid from the control valve 282 both to the brake 200 (through flow line A as indicated in FIG. 2) as well as through the control valve 288 which may be positioned in a second position to flow the hydraulic fluid to the piston accumulator 240 (through flow line B as indicated in FIG. 2), the piston accumulator 240 configured to receive and hold the excess hydraulic fluid for subsequent use when required by the wet brake system 170, as stated above.

The wet brake system 170 may include a control valve 281, which controls the flow of the heated high-pressure hydraulic fluid after flowing through the brake 200. The control valve 281 may be positionable between a first position and a second position. When the control valve 281 is positioned in the first position, the control valve 281 may flow the heated high-pressure hydraulic fluid to the control valve 288, which may be positioned in a third position to flow the heated high-pressure hydraulic fluid to the piston accumulator 240. When the control valve 281 is positioned in the second position, the control valve 281 may flow the hydraulic fluid to a control valve 283, which controls the flow of the heated, high-pressure hydraulic fluid to one or both of the heat exchanger 101 or a heat exchanger 102 of the wet brake system 170, as further described.

In accordance with some aspects of the disclosure, the control valve 283 may be positionable among multiple positions. In one position, the control valve 283 may flow all of the heated hydraulic fluid to the heat exchanger 101. In another position, the control valve 283 may flow all of the heated hydraulic fluid to the heat exchanger 102. In still other positions, the control valve 283 may flow variable amounts of the hydraulic fluid to both the heat exchanger 101 as well as the heat exchanger 102. After the heated high-pressure hydraulic fluid flows through one or both of the heat exchanger 101 or the heat exchanger 102, the high-pressure hydraulic fluid may be cooler, and the cooled hydraulic fluid may flow back to the low-pressure hydraulic fluid supply 220.

In accordance with some aspects of the disclosure, the heat exchanger 101 may be configured to heat material in the bed 150 of the machine 100. Thus, in some examples, the heat exchanger 101 may be a heat exchanger that is embedded in the bed 150 of the machine 100. In accordance with some aspects of the disclosure, the heat exchanger 101 may be a serpentine tube type of heat exchanger 101, which is embedded in a portion (e.g., a bottom) of the bed 150 (FIG. 1), and which is configured ordinarily to receive hot exhaust such as from an internal combustion engine. Flowing the heated high-pressure hydraulic fluid through the heat exchanger 101 may heat the bed 150 of the machine 100, as well as the materials in the bed 150 of the machine 100, which also cools the high-pressure hydraulic fluid, as the heat from the hydraulic fluid is transferred to the bed 150 of the machine 100 as well as to the materials in the bed 150. Heating the bed 150 of the machine 100 as well as the materials within the bed 150 of the machine 100 may facilitate dumping of cold materials in the bed 150 of the machine 100, such as when the machine 100 delivers the materials to the dumpsite on the worksite.

In accordance with some aspects of the disclosure, the heat exchanger 102 may be configured to heat the air within an enclosure in which the heat pump 103 (FIG. 1) of the wet brake system 170 is installed, the heat pump 103 used to heat an interior of the cab 160 of the machine. Flowing the heated high-pressure hydraulic fluid through the heat exchanger 102 may heat the air surrounding the heat pump 103, which also cools the high-pressure hydraulic fluid as the heat is transferred from the heated high-pressure hydraulic fluid to the air. By preheating the air surrounding the heat pump 103 with the heat exchanger 102, the thermal efficiency of the heat pump 103 that heats the air inside the cab 160 of the machine 100 may be increased.

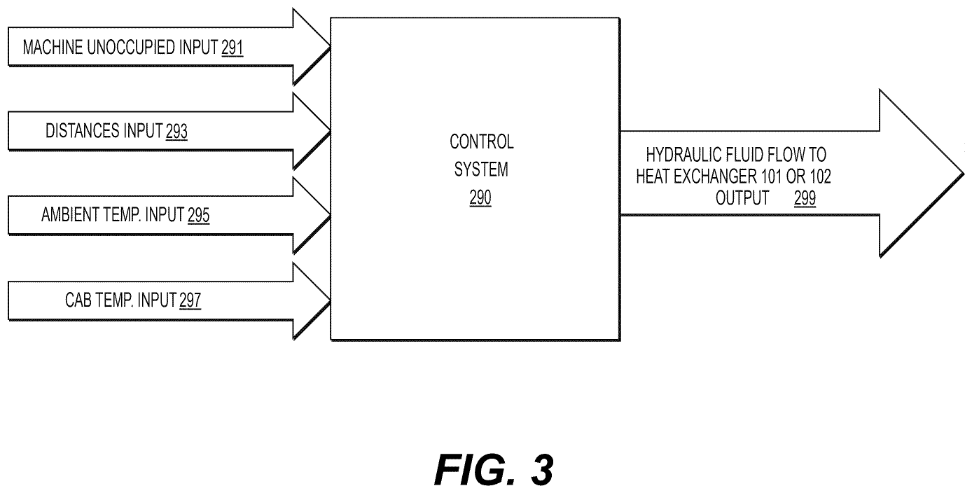

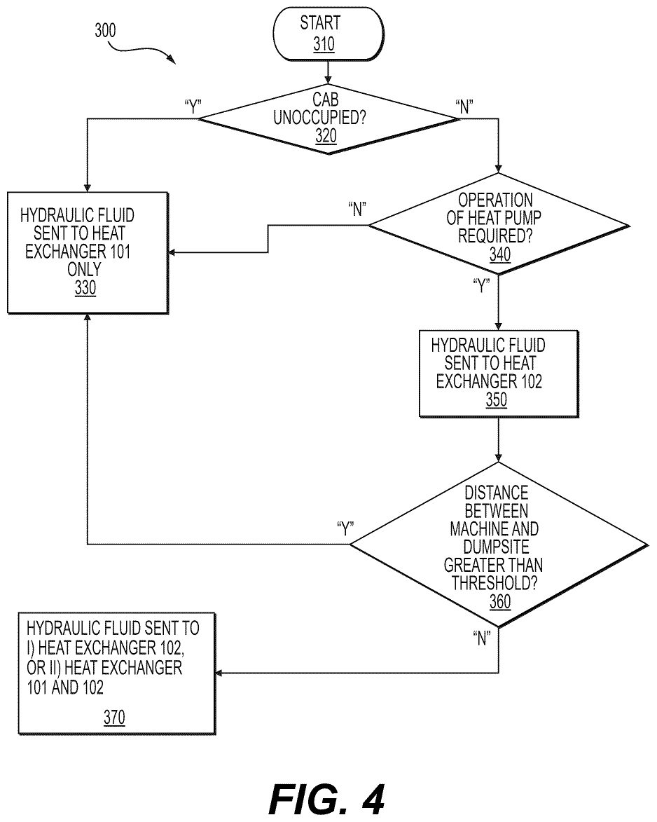

As FIG. 2 illustrates, in some aspects of the disclosure, the wet brake system 170 may include a control system 290, which may control operation of one or more components of the wet brake system 170. For example, the control system 290 may generate commands to control operation of various valves of the wet brake system 170, such as one or more of the control valve 281, the control valve 282, the control valve 283, or the control valve 288. The control system 290 may include one or more controllers, which may embody a single microprocessor or multiple microprocessors for performing any of the operations mentioned herein. In some aspects of the disclosure, the control system 290 may include a memory, a secondary storage device, a processor, such as a central processing unit, or any other system for accomplishing a task consistent with the present disclosure. The memory or secondary storage device associated with the control system 290 may be non-transitory computer-readable media that stores data or software routines that may assist the control system 290 in performing its functions, such as the functions of method or process discussed with reference to FIGS. 3 and 4 below. Further, the memory or secondary storage device associated with the control system 290 may also store data received from the various inputs or sensors associated with the machine 100, including the inputs and outputs discussed below. Numerous commercially available microprocessors may be configured to perform one or more of the functions of the control system 290. In some aspects of the disclosure, the control system 290 may include a general machine controller capable of controlling numerous other machine functions. Various other known circuits may be associated with the control system 290, including signal-conditioning circuitry, communication circuitry, hydraulic or other actuation circuitry, or other appropriate circuitry.

FIG. 3 illustrates a schematic block diagram of an exemplary configuration of the control system 290, according to some aspects of the disclosure. As discussed above, the control system 290 may control operation of various components of the wet brake system 170 by issuing commands for actuators of the wet brake system 170, including one or more valves of the wet brake system 170. FIG. 3 illustrates and the foregoing discussion describes operation of the control system 290 to position the control valve 283 to flow the heated high-pressure hydraulic fluid through one or both of the heat exchanger 101 or the heat exchanger 102, as further described.

As FIG. 3 illustrates, the control system 290 may receive an input 291 indicating whether the cab 160 of the machine 100 is unoccupied. The input 291 may be provided by one or more of the sensors 180, or through other systems or subsystems of or associated with the machine 100.

The control system 290 may receive an input 293 indicating a distance between a current location of the machine 100 on the worksite, and a location of the dumpsite on the worksite to which the machine 100 is traveling to dump material in the bed 150 of the machine 100. The input 293 may be provided by one or more of the sensors 180, or through other systems or subsystems of or associated with the machine 100, including a global positioning system (GPS), for example.

The control system 290 may receive an input 295 indicating an ambient temperature of the worksite on which the machine 100 is operating. The input 295 may be provided by one or more of the sensors 180, or through other systems or subsystems of or associated with the machine 100.

The control system 290 may receive an input 297 indicating a temperature within the cab 160 of the machine 100. The input 295 may be provided by one or more of the sensors 180, or through other systems or subsystems of or associated with the machine 100.

As FIG. 3 illustrates, the control system 290 may receive one or more, or all, of the input 291, the input 293, the input 295, or the input 297, and may provide an output 299. The output 299 may control operation of the control valve 283, for example, to determine how much of the heated high-pressure hydraulic fluid flows through one or both of the heat exchanger 101, to heat the bed 150 of the machine 100, as well as the materials in the bed 150 of the machine 100, or the heat exchanger 102, to heat the air surrounding the heat pump 103 that heats the air in the cab 160 of the machine 100.

### INDUSTRIAL APPLICABILITY

In accordance with aspects of the disclosure, the described and illustrated wet brake system 170 may be used in various types of machines, including a mobile machine in the form of a large mining truck (LMT). The wet brake system 170 may be used to cool the hydraulic fluid that is heated by frictional torque generated during braking events. During a braking event, the brake actuator 218 may flow high-pressure hydraulic fluid into the brake 200, which may push the friction discs 210 and the separator discs 212 toward one another. As the friction discs 210 and the separator discs 212 approach one another, frictional torque may be generated between the friction discs 210 and the separator discs 212, and as a result rotation of the axles 140 may be slowed. This frictional torque generated during the braking event may heat the high-pressure hydraulic fluid, and this heated high-pressure hydraulic fluid then should be cooled to prevent degradation of the hydraulic fluid as well as damage to components of the brake 200.

Further, the wet brake system 170 may be used to provide heat to the bed 150 of the machine 100, to heat the bed 150 as well as the materials in the bed 150, which may facilitate dumping of cold materials in the bed 150. Still further, the wet brake system 170 may be used to heat the volume of air surrounding the heat pump 103, which is used to heat the interior of the cab 160. Because the efficiency of the heat pump 103 may depend on the temperature of the air surrounding the heat pump 103, the efficiency of the heat pump 103 may be increased, as the efficiency of the heat pump 103 increases as temperature increases. In accordance with some aspects of the disclosure, the wet brake system 170 may include the control system 290, which controls operation of the control valve 183, to determine whether the heated high-pressure hydraulic fluid from the brake 200 flows through either or both of the heat exchanger 101 or the heat exchanger 102.

FIG. 4 illustrates a flow chart of an exemplary method 300 for operation of the control system 290, in accordance with some aspects of the disclosure. As FIG. 4 shows, the method 300 may begin at start 310. The method 300 may continue to a step 320, where a determination may be made as to whether the cab 160 of the machine 100 is unoccupied, such as by one or more of the sensors 180 providing the input 291, as described with reference to FIG. 3, or by determining that the machine 100 is under a remote control mode or a fully autonomous operation mode. This determination may establish whether the hydraulic fluid flows or does not flow to the heat exchanger 102. When the answer at step 320 is “Yes,” indicating that the cab is unoccupied, there may be no reason to flow the hydraulic fluid to the heat exchanger 102 used to heat the volume of air surrounding the heat pump 103 responsible for heating the cab 160 of the machine 100. Thus, as indicated at step 330, the control system 290 may generate an output causing the heated high-pressure hydraulic fluid to flow only to the heat exchanger 101 to heat the bed 150 of the machine, as well as the material within the bed 150 of the machine 100, but not to the heat exchanger 102. Thus, the control system 290 may control operation of the control valve 283 to flow the heated high-pressure hydraulic fluid through the heat exchanger 101 only. However, in some instances, some portion of the heat high-pressure hydraulic fluid may still flow to the heat exchanger 102.

When the answer at step 320 is “No,” which indicates that the cab is occupied, the hydraulic fluid may flow to the heat exchanger 102 that may be used to heat the volume of air surrounding the heat pump 103 responsible for heating the cab 160 of the machine 100. Thus, as indicated by step 340, a determination may be made as to whether operation of the heat pump 103 may be required (e.g., whether it is cold within the cab of the machine). This determination may be made by measuring, with one or more of the sensors 180 providing the input 297 as described with reference to FIG. 3, for example, a temperature within the cab 160 of the machine 100, and comparing the measured temperature to the predetermined threshold temperature value, such as by using the control system 290. When the answer at step 340 is “No,” indicating that operation of the heat pump 103 for heating the cab 160 of the machine 100 may not be required, as discussed above and as indicated by step 330, the control system 290 may generate an output causing the heated high-pressure hydraulic fluid to flow only to the heat exchanger 101 and not to the heat exchanger 102. Thus, the control system 290 may control operation of the control valve 283 to flow the heated high-pressure hydraulic fluid through the heat exchanger 101 only.

When the answer at step 340 is “Yes,” that operation of the heat pump 103 for heating the cab 160 may be required, as indicated by step 350, the control system 290 may generate an output causing the hydraulic fluid to flow to the heat exchanger 102, such that the volume of air surrounding the heat pump 103 may be heated, and the heat pump 103 may operate to heat the inside of the cab 160 of the machine 100. Thus, the control system 290 may control operation of the control valve 283 to flow the heated high-pressure hydraulic fluid through the heat exchanger 102.

As FIG. 4 further illustrates, as indicated by step 360, a determination may be made as to whether a distance between a current location of the machine 100 on the worksite, and the location of a destination, such as a dumpsite at which material in the bed 150 of the machine 100 is to be dumped, is greater than a predetermined threshold distance. This determination may be made by measuring, with one or more of the sensors 180 or a GPS system providing the input 293 as described with reference to FIG. 3, for example, and comparing the determined distance to predetermined threshold distance, such as by using the control system 290.

When the answer at step 360 is “Yes,” that the distance to the destination is greater than the predetermined threshold distance, as discussed above and as indicated by step 330, the hydraulic fluid may flow only to the heat exchanger 101, to thereby heat the bed 150 of the machine 100 as well as the materials within the bed 150 of the machine 100. Thus, the control system 290 may control operation of the control valve 283 to flow the heated high-pressure hydraulic fluid through the heat exchanger 101.

When the answer at step 360 is “No,” indicating that the distance to the dumpsite or other destination is less than or equal to the predetermined threshold distance, as step 370 indicates, the hydraulic fluid may flow to either i) only the heat exchanger 102 or ii) both the both heat exchanger 101 and the heat exchanger 102. In some instances, the amount of hydraulic fluid that the control system 290 causes to flow to the heat exchanger 102 or the heat exchanger 101 may depend on the ambient temperature, as determined by one or more of the sensors 180 providing the input 295 as described with reference to FIG. 3, the temperature within the cab 160 of the machine 100, as determined by one or more of the sensors 180 providing the input 297 as described with reference to FIG. 3, and the ability of the heat pump 103 to heat the cab 160 (e.g., the efficiency of the heat pump 103). In some instances, the control system 290 may store data in the form of a map, table, spreadsheet, or other information, and may determine the percentage of the heated high-pressure hydraulic fluid that is flowed to each of the heat exchanger 101 and the heat exchanger 102 based on the data.

The foregoing systems and method may provide one or more advantages. As discussed, the machine 100 may heat the bed 150 and the materials within the bed 150, thereby facilitating the dumping of the materials from the bed 150 to the dumpsite on the worksite. Further, the machine 100 may heat the air surrounding the heat pump 103, thereby increasing the efficiency of the heat pump 103 that is used to heat the interior of the cab 160. The use of the heat produced by the braking event, using the wet brake system 170, allows the machine 100 with the electric drive system 120 to heat the bed 150 as well as the air surrounding the heat pump 103.

It will be apparent to those skilled in the art that various modifications and variations may be made to the disclosed system without departing from the scope of the disclosure. Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A mobile machine, comprising:
a cab including an interior;
an electric drive system;
at least one wheel configured to be driven by the electric drive system;
a bed configured to receive materials and to dump the materials at a dumpsite; and
a wet brake system configured to slow rotation of the at least one wheel during a braking event, the wet brake system comprising:
a hydraulic fluid supply configured to supply hydraulic fluid;
a brake configured to receive the hydraulic fluid from the hydraulic fluid supply, the brake configured to slow rotation of the at least one wheel during the braking event;
a first heat exchanger configured to provide heat for the bed;
a second heat exchanger configured to provide heat for heating the interior of the cab; and
a control system configured to generate commands to cause flow of the hydraulic fluid from the brake to one or both of the first heat exchanger or the second heat exchanger.

2. The mobile machine of claim 1, wherein the brake comprises a plurality of friction discs, and a plurality of separator separat discs between the friction discs.

3. The mobile machine of claim 1, wherein the first heat exchanger comprises a serpentine heat exchanger embedded in the bed.

4. The mobile machine of claim 1, wherein the control system is configured to generate commands to cause all of the hydraulic fluid to flow to the first heat exchanger when the cab is unoccupied.

5. The mobile machine of claim 1, wherein the control system is configured to generate commands to cause flow of at least a portion of the hydraulic fluid to the second heat exchanger when i) the cab is occupied and ii) a temperature inside the cab is less than a threshold temperature.

6. The mobile machine of claim 1, wherein the control system is configured to generate commands to cause flow of at least a portion of the hydraulic fluid to the second heat exchanger when i) the cab is occupied and ii) a difference between a location of the mobile machine on a worksite and a location of the dumpsite on the worksite is greater than a threshold distance.

7. The mobile machine of claim 1, wherein the control system is configured to flow all of the hydraulic fluid to the first heat exchanger when i) the cab is occupied but ii) a difference between a location of the mobile machine on a worksite and a location of the dumpsite on the worksite is less than a threshold distance.

8. The mobile machine of claim 1, wherein the control system is configured to control a position of a valve to determine an amount of hydraulic fluid to flow to the second heat exchanger based on an ambient temperature of a worksite.

9. The mobile machine of claim 1, wherein the wet brake system further comprises a control valve configured to be controlled by the control system, wherein the control valve is configured to be positioned to flow all of the hydraulic fluid to the first heat exchanger, all of the hydraulic fluid to the second heat exchanger, or a portion of the hydraulic fluid to the first heat exchanger and a portion of the hydraulic fluid to the second heat exchanger.

10. A wet brake system configured to apply braking to reduce a speed of a wheel of a mobile machine during a braking event, the wet brake system comprising:
a hydraulic fluid supply configured to supply hydraulic fluid;
a brake configured to receive the hydraulic fluid from the hydraulic fluid supply, the brake configured to apply braking to reduce the speed of the wheel during the braking event;
a first heat exchanger configured to provide heat for increasing a temperature of a bed of the mobile machine which is configured to receive materials;
a second heat exchanger associated with a heat pump configured to heat a cab of the mobile machine; and
a control system configured to generate commands to cause a flow of the hydraulic fluid from the brake to one or both of the first heat exchanger or the second heat exchanger.

11. The wet brake system of claim 10, wherein the brake comprises a plurality of friction discs and a plurality of separator discs between the friction discs.

12. The wet brake system of claim 10, wherein the control system is configured to generate commands to cause flow of all of the hydraulic fluid to the first heat exchanger when the cab is unoccupied.

13. The wet brake system of claim 10, wherein the control system is configured to generate commands to cause flow of at least a portion of the hydraulic fluid to the second heat exchanger when i) the cab is occupied and ii) a temperature inside the cab is less than a threshold temperature.

14. The wet brake system of claim 10, wherein the control system is configured to generate commands to cause flow of at least a portion of the hydraulic fluid to the second heat exchanger when i) the cab is occupied and ii) a difference between a location of the mobile machine on a worksite and a location of a dumpsite on the worksite is greater than a threshold distance.

15. The wet brake system of claim 10, wherein the control system is configured to generate commands to cause flow of all of the hydraulic fluid to the first heat exchanger when i) the cab is occupied but ii) a difference between a location of the mobile machine on a worksite and a location of a dumpsite on the worksite is less than a threshold distance.

16. The wet brake system of claim 10, wherein the wet brake system further comprises a control valve configured to be controlled by the control system, wherein the control valve is configured to be positioned to flow all of the hydraulic fluid to the first heat exchanger, all of the hydraulic fluid to the second heat exchanger, or a portion of the hydraulic fluid to the first heat exchanger and a portion of the hydraulic fluid to the second heat exchanger.

17. A mobile machine, comprising:
an electric drive system including batteries configured to provide electrical power and a motor configured to operate on the electrical power;
a cab including an interior;
a heat pump configured to heat the interior of the cab;
a wheel configured to be driven by the electric drive system, the wheel configured to propel the mobile machine across a ground surface of a worksite;
a bed configured to receive materials and to dump the materials at a dumpsite on the worksite; and
a brake system configured to slow rotation of the wheel during a braking event, the brake system comprising:
a hydraulic fluid supply configured to supply hydraulic fluid;
a brake configured to receive the hydraulic fluid from the hydraulic fluid supply, the brake configured to slow the rotation of the wheel during the braking event;
a first heat exchanger configured to heat the bed;
a second heat exchanger configured to heat a volume of air surrounding the heat pump;
a control valve configured to flow hydraulic fluid from the brake to one or both of the first heat exchanger or the second heat exchanger; and
a control system configured to control operation of the control valve to flow the hydraulic fluid from the brake to one or both of the first heat exchanger or the second heat exchanger, based on at least one of i) whether the cab is occupied, ii) a temperature within the cab, iii) a distance between the mobile machine on the worksite and the dumpsite, or iv) an ambient temperature.

18. The mobile machine of claim 17, wherein the control system is configured to position the control valve to flow all of the hydraulic fluid to the first heat exchanger when the cab is unoccupied.

19. The mobile machine of claim 17, wherein the control system is configured to position the control valve to flow at least a portion of the hydraulic fluid to the second heat exchanger when i) the cab is occupied and ii) the distance between the mobile machine on the worksite and the dumpsite is greater than a threshold distance.

20. The mobile machine of claim 17, wherein the control system is configured position the control valve to flow all of the hydraulic fluid to the first heat exchanger when i) the cab is occupied but ii) the distance between the mobile machine on the worksite and the dumpsite is greater than a threshold distance.
